(19) United States
(12) Patent Application Publication
(10) Pub. No.: US 2017/0005341 A1
(43) Pub. Date: Jan. 5, 2017

(54) HIGH PERMEABILITY OXYGEN SEPARATION MEMBRANE COATED WITH ELECTROACTIVE LAYER ON BOTH SIDES AND FABRICATION METHOD THEREOF

(71) Applicant: KOREA INSTITUTE OF ENERGY RESEARCH, Daejeon (KR)

(72) Inventors: Ji-haeng YU, Daejeon (KR); Jong-hoon JOO, Cheongju-si (KR); Kyung Sic YUN, Sejong-si (KR); Chung-yul YOO, Daejeon (KR)

(21) Appl. No.: 15/003,428

(22) Filed: Jan. 21, 2016

Related U.S. Application Data
(60) Provisional application No. 62/186,617, filed on Jun. 30, 2015.

(51) Int. Cl. H01M 4/88; H01M 8/1246; H01M 8/126; H01M 8/1213; H01M 8/1253

(52) U.S. Cl. CPC H01M 4/881; H01M 8/1213; H01M 8/1253; H01M 8/126; H01M 8/1246

(57) ABSTRACT

The present disclosure discloses an oxygen separation membrane with high permeability coated with electroactive materials on both sides thereof in which electronic conductive materials and ionic conductive materials are mixed in an optimal ratio whereby the oxygen separation membrane according to the present disclosure has high oxygen permeability and a good thermal stability. Further the present membrane can be advantageously prepared using a simple process such as Tape casting and using a simple sintering process.

### CROSS-REFERENCE TO RELATED APPLICATIONS

This application claims the benefit of U.S. Provisional Application No. 62/186,617 filed Jun. 30, 2015 in USPTO, disclosure of which is incorporated herein by reference.

### STATEMENT OF GOVERNMENT SUPPORT

The invention was made with government support under grant number (GP2014-0082) “Development of Low-cost Oxygen Production Technology using Oxygen Transport Membrane” awarded by Ministry of Science, ICT and Future Planning, Republic of Korea.

### BACKGROUND

Field

The present disclosure generally relates to a gas separation membrane, particularly high permeability oxygen separation membranes.

Discussion of the Related Technology

Ion permeable ceramic separation membranes for gas permeation are mainly divided into pure ion conducting membranes and MIEC (mixed ionic-electronic conducting) membranes. The former requires external power source and electrodes to provide currents by which the permeability of the ionic gases is finely controlled. In contrast, MIEC membranes do not require an external power source and allows for the ionic transport of gases due to the differential partial pressure of gas across the membrane.

The related technology is disclosed in V. V. Kharton, A. V. Kovalevsky, A. P. Viskup, F. M. Figueiredo, A. A. Yaremchenko, E. N. Naumovich, F. M. B. Marques, J. Electrochem. Soc. 2000, 147, 2814./K. Wu, S. Xie, G. S. Jiang, W. Liu, C. S. Chen, J. Membr. Sci. 2001, 188, 189./J. Yi, Y. Zuo, W. Liu, L. Winnubst, C. Chen, J. Membr. Sci. 2006, 280, 849. The related technology is additionally disclosed in U.S. Pat. No. 7,556,676; U.S. Pat. No. 5,922,860; V. V. Kharton, A. V. Kovalevsky, A. P. Viskup, F. M. Figueiredo, A. A. Yaremchenko, E. N. Naumovich, F. M. B. Marques, J. Electrochem. Soc. 2000, 147, 2814; K. Wu, S. Xie, G. S. Jiang, W. Liu, C. S. Chen, J. Membr. Sci. 2001, 188, 189; and J. Yi, Y. Zuo, W. Liu, L. Winnubst, C. Chen, J. Membr. Sci. 2006, 280, 849.

### SUMMARY

In one aspect, there are provided oxygen separation membranes with excellent oxygen conductivity as well as thermal stability by controlling the mixed ratio of the electric conductive material and ionic conductive material and coating both sides thereof with electroactive layers.

In one aspect, the present disclosure provides an oxygen separation membrane with high permeability coated with electroactive layers on both sides thereof comprising: an ion-electronic mixed membrane layer with 20 to 300 μm in thickness wherein the ion-electronic mixed membrane layer comprises a mixture of either an electronic conductive material or an ionic-electronic mixture and an ionic conductive material in a volume ratio from 2:8 to 3:7; porous electroactive layers which are coated on both sides of the ion-electronic mixed membrane layer symmetrically or asymmetrically with 20 to 100 μm in thickness wherein the electroactive layers comprise least one ion-electronic mixed conductive materials.

In one embodiment, the ion-electronic mixed membrane layer comprises a mixture of the electronic conductive material and the ionic conductive material having an ion conductivity of 0.1 S/cm or more wherein the electronic conductivity of the ion-electronic mixed membrane layer is 0.5 S/cm or more, and wherein the electroactive layer has an electronic conductivity of 10 S/cm or more, and an ion conductivity of 0.03 S/cm or more.

In other embodiment, the electronic conductive material contained in the present membrane is at least one selected from a group consisting of Lanthanum strontium Manganite, Lanthanum strontium Chromite, MnFe2O4, and NiFe2O4.

In still other embodiment, the ionic conductive material is at least one selected from a group consisting of yttria-stabilized zirconia, scandia-stabilized zirconia, gadolinium doped-ceria, Samaria doped-Ceria, Lanthanum gallates doped with magnesium and strontium, and Bismuth oxide.

In still other embodiment, the ionic-electronic mixed conductive material is at least one selected from a group consisting of SrTi1-xFexO3-δ, Lanthanum strontium ferrite, Lanthanum strontium cobaltite, Strontium cobalt ferrite, Barium strontium cobalt ferrite, Lanthanum strontium cobalt ferrite and Lanthanum nickelate.

In other aspect, the present disclosure provides a method of fabricating the present membrane which comprise a step of preparing an ion-electronic mixed membrane layer using a tape casting process in which each of either an electronic conductive material or an ionic-electronic material is mixed with an ionic conductive material in a volume ratio from 2:8 to 3:7; a step of sintering and densificating the membrane layer at 1200° C. to 1400° C.; a step of coating both sides of the ion-electronic mixed membrane layer with a porous electroactive layer in a thickness of 20 to 100 μm; and a step of heat-treating the coated membrane at a temperature of 900° C. to 1100° C.

In still other aspect, the present disclosure provides a method of fabricating the present membrane which comprises a step of preparing an ion-electronic mixed membrane layer using a tape casting process in which either an electronic conductive material or an ionic-electronic material is mixed with an ionic conductive material in a volume ratio from 2:8 to 3:7; a step of coating both sides of the ion-electronic mixed membrane layer with a porous electroactive layer in a thickness of 20 to 100 μm; and a step of sintering and densificating the coated membrane layer at 1200° C. to 1400° C.

In one embodiment, the ion-electronic mixed membrane layer is prepared by combining the electronic conductive material and the ionic conductive material having an ion conductivity of 0.1 S/cm or more wherein the electronic conductivity of the ion-electronic mixed membrane layer is 0.5 S/cm or more, and wherein the electroactive layer has an electronic conductivity of 10 S/cm or more, and an ion conductivity of 0.03 S/cm or more.

In other embodiment, the electronic conductive material is at least one selected from a group consisting of Lanthanum strontium Manganite, Lanthanum strontium Chromite, MnFe2O4, and NiFe2O4.

In still other embodiment, the ionic conductive material is at least one selected from a group consisting of yttria-stabilized zirconia, scandia-stabilized zirconia, gadolinium doped-ceria, Samaria doped-Ceria, Lanthanum gallates doped with magnesium and strontium, and Bismuth oxide.

In still other embodiment, the ionic-electronic mixed conductive material is at least one selected from a group consisting of SrTi1-xFexO3-δ, Lanthanum strontium ferrite, Lanthanum strontium cobaltite, Strontium cobalt ferrite, barium strontium cobalt ferrite, Lanthanum strontium cobalt ferrite and Lanthanum nickelate.

The foregoing summary is illustrative only and is not intended to be in any way limiting. Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph showing the oxygen conductivity at 850° C. and electronic conductivity at 300° C. with changes in the ratio of the volume of LSM comprised in the LSM-GDC MIEC membrane layer.

FIG. 2 is a graph showing the electronic conductivity with the ratio of LSCF comprised in the LSM-GDC MIEC membrane layer.

FIG. 3 is a graph showing the oxygen conductivity with the ratio of LSCF comprised in the LSM-GDC MIEC membrane layer.

FIG. 4 is a graph showing Thermal Expansion Coefficient measured with temperature changes on the LSCF-GDC MIEC membrane in which LSCF and GDC were mixed in the ratio of 2:8.

FIG. 5 is a graph showing the oxygen conductivity of the MIEC membrane (LSCF: GDC=2:8) with temperature changes in which mixed conductive materials (LSC, STF, LSCF, BSCF) and electro conductive material (LSM) were used as a electroactive layer.

FIG. 6 is a graph showing the changes in the oxygen conductivity with coating the LSM-GDC (20:80) (upper) and LSCF-GDC (20:80) (lower) membrane with electroactive layer on one or both sides.

FIG. 7 is a schematic diagram showing the mechanism of oxygen permeation through the MIEC membrane coated with mixed conductive electroactive layers on both sides according to one embodiment of the present disclosure.

FIG. 8 is a graph showing the oxygen conductivity with changes in the thickness of MIEC membranes (LSCF:GDC=20:80, LSM:GDC=20:80, LSM-GDC=50:50) according to one embodiment of the present disclosure.

FIG. 9 is an microscopic image of MIEC membrane (LSCF-GDC(50:50, 483 μm)/LSM-GDC (20:80, 8 μm)/LSC(11 μm)) having asymmetry in the thickness of mixed conductive electroactive layers and materials for the same.

FIG. 10 is a graph showing the oxygen conductivity with temperature in MIEC membranes (LSM:GDC=20:80) each having 8, 24, 40, and 80 μm in thickness between the two mixed conductive electroactive layer as shown in FIG. 9.

### DETAILED DESCRIPTION OF EMBODIMENTS

The main types of MIEC are single phase MIECs having single phase Perovskite structures transporting both ionic gas and electrons, and dual phase MIEC membranes including electronic conductive oxides or metal phase and ionic conductive fluorite phase, in which the electrons and ionic gases permeate through two different phases.

The Perovskite structures comprised in the single phase MIEC membranes are chemically unstable because the Perovskite structure are destroyed by a reaction between Perovskite and acidic or reducing gases such as H2S, H2O, CH4 and the like. That is, most of mixed ionic-electronic conducting oxides tend to decompose into carbonate or hydroxide forms and which may impose problems in practical applications.

The fluorite phase or structures comprised in dual phase MIEC membranes are resistant to acidic or reducing gases. Thus the dual phase MIEC membranes comprise ion conducting materials selected from yttria-stabilized zirconia (YSZ), scandia-stabilized zirconia (ScSZ), Sm-doped ceria(SDC) or gadolinium-doped ceria (GDC) or LaGaO3; and metal phase selected from Ag, Pd, Au or Pt.

The fluorite phase or structures used in Solid Oxide Fuel Cell (SOFC) are thermally stable under reducing or CO₂ atmospheres and thus used to improve the chemical stability of ceramic membranes for oxygen separation. Also, Thermal Expansion Coefficient (TEC) of the fluorite structures are low relative to the Perovskite structures as about 10 to 12×10⁻⁶K⁻¹ and thus it may be used to improve the mechanical stability of the membranes. The dual phase MIEC membranes having more fluorite oxides show strong mechanical stability when exposed to an oxygen chemical potential gradient due to the absence of or almost no chemical expansion resulting from the changes of oxygen partial pressure. Also required is a minimum amount of Perovskite phase comprised in the dual phase membranes to improve the overall stability of the membranes.

However, the current MIEC membranes developed have been reported to have a low oxygen conductivity despite of the high ionic conductivity from ionic conductive materials (for example GDC). These results from the lack of understanding of the effect on the reaction, i.e., O₂+4e-2O-2 occurring at the surface and of the necessity of mixed conductive active layers in MIEC s.

In the present disclosure, embodiments of oxygen separation membrane coated with electroactive layer on both sides thereof with high permeability to oxygen and fabrication methods thereof are discussed.

The term “separation membrane” as used herein refers to an interface material with function of selectively transporting certain materials between the two phases. That is, when a mixture of gases contacts the surface of a membrane, the gases dissolve and diffuse into the membrane in which case, the solubility and conductivity of each gas varies depending on the membranes used. The driving force of the separation is the differential partial pressure of a particular gas across the membrane. Particularly the separation process employing the membranes has advantages over others due to the no changes in phases and low energy consumption.

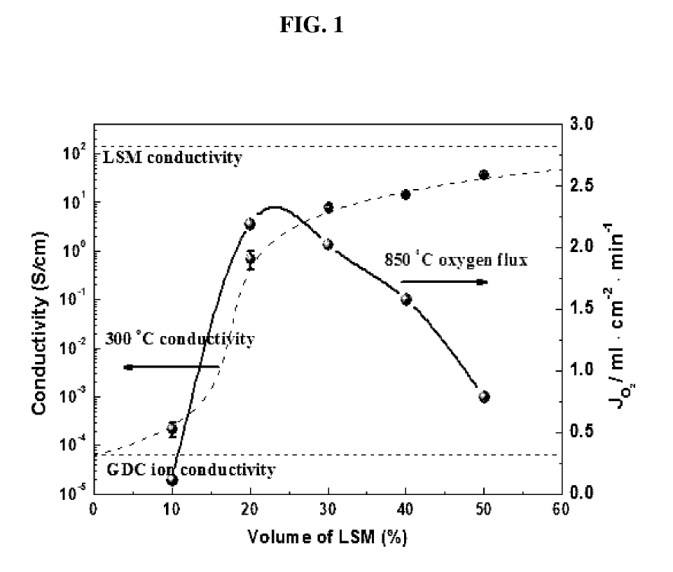

FIG. 1 is a graph showing the oxygen conductivity at 850° C. and electronic conductivity at 300° C. with changes in the ratio of the volume of LSM comprised in the LSM-GDC MIEC membrane layer. As shown in FIG. 1, the oxygen conductivity of 1 mL/cm² min or more was observed when the volume ratio of LSM is in the range of 20 to 30%. In one aspect of the present disclosure, the present disclosure relates to an oxygen separation membrane with a high permeability coated with electroactive layers on both sides thereof comprising an electronic ionic mixed membrane layer with 20 to 300 μm in thickness wherein the electronic ionic mixed membrane layer comprises an electronic conductive material and an ionic-electronic in a volume ratio from 2:8 to 3:7; and porous electroactive layers coating both sides of the ion-electronic mixed membrane layer symmetrically or asymmetrically with 20 to 100 μm in thickness wherein the electroactive layers comprise least one ion-electronic mixed conductive materials. In the present disclosure, it was discovered that the oxygen conductivity is improved when both sides of EIMC membranes are coated.

In one embodiment of the present disclosure, the EIMC membranes according to the present disclosure have an electric conductivity of 0.5 S/cm or more and are made of an ionic conductive or ionic-electronic mixed conductive material with ionic conductivity of 0.1 S/cm or more which is combined with an electric conductive material. Before the mixture, the electric conductivity of the electric conductive material used is 10 S/cm or more which is about 100 times higher than the ionic conductivity of the ionic conductive material. However, the values are decreased to several times after they were mixed. The gas conductivity is determined by the lessor of the ionic conductivity and electric conductivity. Thus the electric conductivity need not be excessively higher than the ionic conductivity and only need to be just higher than the ionic conductivity.

In one embodiment, the electroactive layers used have an electronic conductivity of 10 S/cm or more and ionic conductivity of 0.03 S/m or more.

The gas separation membrane of the present disclosure is an oxygen separation membrane comprising an ionic electronic mixed membrane layer in which each of either electronic conductive material or ionic-electronic mixed conductive material is mixed with ionic conductive material. In one embodiment, the electronic conductive material is a perovskite type of material which is an oxide of electronic conductive material and is for example at least one selected from a group consisting of Lanthanum strontium Manganite (LSM), Lanthanum strontium Chromite (LSCr), MnFe₂O₄, and NiFe₂O₄.

In one embodiment of the present disclosure, the ionic conductive materials is a fluorite type of material and is for example at least one selected from a group consisting of yttria-stabilized zirconia (YSZ), scandia-stabilized zirconia (ScSZ), gadolinia doped-ceria (GDC), Samaria doped-Ceria, Lanthanum gallates doped with magnesium and strontium (LSGM), and Bismuth oxide. In one embodiment, ionic electronic mixed membrane layer is a mixture or composite of Lanthanum strontium cobalt ferrite (LSCF), which is an ionic electronic mixed conductive material, and gadolinia doped-ceria (GDC) which is a ionic conductive material. In one embodiment, ionic electronic mixed membrane layer is a mixture or a composite of Lanthanum strontium Manganite (LSM) as an electronic conductive material and gadolinia doped-ceria (GDC) as an ionic conductive material.

In one embodiment, the ionic-electronic mixed conductive material of the present disclosure is at least one selected from a group consisting of SrTi1-xFexO3-δ (STF), Lanthanum strontium ferrite (LSF), Lanthanum strontium cobaltite (LSC), Lanthanum Strontium Chromite (LSCr), Lanthanum strontium cobalt ferrite (LSCF) and Lanthanum nickelate (LNO).

In the oxygen separation membrane of the present disclosure, the ratio of the material comprised in the ionic-electronic conductive membrane layer is controlled, and the membrane is prepared to have a dense structure and coated on both sides thereof with porous conductive electroactive layer to achieve the highest efficiency in both electronic and oxygen ionic conductivity. In the present ionic-electronic mixed membrane, the electronic ionic material and the ionic conductive material is mixed in a volume ratio of 1.5:8.5 to 5:5, preferably 2:8 to 3:7. The materials may be mixed by a method known in the art. Also the membrane of the present disclosure has a thickness of 20 μm to 300 μm. Thickness less than 20 μm is not excluded. However considering the ease of fabrication and the mechanical strength of the membrane, it is preferable that the membrane has a thickness of at least of 20 μm. It is preferable that the membrane has a thickness of 300 μm or less considering the oxygen permeability.

The electroactive layer of the present disclosure works as a catalyst for the ionization of oxygen and the gasification reaction of the ionized oxygen ion and preferably comprises at least one ionic-electronic mixed conductive material with an electronic conductivity of 10 S/m or more and an ionic conductivity of 0.03 S/m or more. Other materials which may be included in the present electroactive layer are for example porous Cermet, porous metal and electro conductive materials and ionic conductive materials and the like and but are not limited thereto. The ionic electronic mixed conductive materials are at least one selected from a group consisting of SrTi₁₋ₓFeₓO_{3-δ}(STF), Lanthanum strontium ferrite (LSF), Lanthanum strontium cobaltite (LSC), Lanthanum strontium Chromite (LSCr), Lanthanum strontium cobalt ferrite (LSCF) and Lanthanum nickelate (LNO).

The cermet is a composite of a metal selected from Nickel, Nickel alloy and iron alloys, and an ionic conductive electrolyte, in which ionic conductive material is at least one selected from yttria-stabilized zirconia (YSZ), scandia-stabilized zirconia (ScSZ), Gd doped-ceria (GDC), Sm doped-Ceria, Lanthanum gallates dope with strontium and magnesium, (LSGM) and Bismuth oxide (Bi₂O₃). Also the porous metal is Nickel or Inconel.

In one embodiment, the ionic-electronic mixed conductive materials contained in the electroactive layer are identical to that of the ionic-electronic mixed conductive membrane layer to minimize the difference in the thermal expansion coefficient in the concomitant sintering.

The electroactive layer is kept to have a thickness of 1 to 100 μm. When the thickness less than 1 μm, the coated layers are easily detached from the separation membrane, and when the thickness is over 100 μm, a problem that the diffusion rate of the gas is not sufficient in the coated layer may be occurring. The thickness of the coated layer is preferable to be 13 to 134% of the thickness of the membrane layer. When the thickness is less than 13%, the increase in the oxygen conductivity exerted by the coating is not sufficient and when the thickness is more than 134%, the diffusion rate of the gas in the coated layer is not sufficient.

In other aspect, the present disclosure relates to a method of fabricating an oxygen separation mixed membrane with high permeability. The present method comprises a step of ionic-electronic mixed membrane layer in which each of either electronic conductive or ionic-electronic conductive material and ionic conductive material is mixed in a volume ratio of 2:8 to 3:7; a step of densification by sintering the membrane at 1200° C. to 1400° C.; and a step of coating the membrane on both sides thereof with a porous electroactive layer in a thickness of 20 to 100 μm; and a step of heat treating the coated membrane at 900° C. to 1100° C.

The present methods employing a tape casting process have simplified steps and the membrane thickness can be easily controlled, and also the continuous productions can also be easily achieved. In the present ionic electronic mixed membrane layer fabricated according to the tape casting process, for a densification of the membrane, a step of sintering at 1200° C. to 1400° C. is performed. On both sides of the sintered mixed membrane, porous conductive electroactive layer are coated, in which the porous structures are maintained for oxygen ions, which are generated from the improved ionization of the oxygen fed on one side, to be diffused to the surface of the mixed membrane and to form gases on the other side by combining with electrons upon arriving at the electroactive layer on the other side. The electroactive layer may coated on both sides symmetrically or unsymmetrically by a process such as tape casting stacking process, a spray method, a screen printing, or by a brush and the like.

In one embodiment, the membrane layer and coating layer are sintered at the same time. The present method performed using a tape casing process and comprises a step of combining each of either electronic conductive or ionic-electronic conductive material with ionic conductive material in a volume ratio of 2:8 to 3:7; a step of coating the membrane on both sides thereof with a porous electroactive layer in a thickness of 20 to 100 μm; a step of densification by sintering the membrane and the coated layer at the same time at 1200° C. to 1400° C. In this case, when the identical ionic-electronic mixed conductive material is used in the membrane layer and electroactive layer, the twist due to the difference in thermal expansion coefficient can be prevented.

The present disclosure is further explained in more detail with reference to the following examples. These examples, however, should not be interpreted as limiting the scope of the present invention in any manner.

### EXAMPLES

### Example 1

### Determination of Electrical Properties According to the Mixed Volume Ratio of LSM and GDC and Preparation of LSM-GDC Mixed Membrane Layer

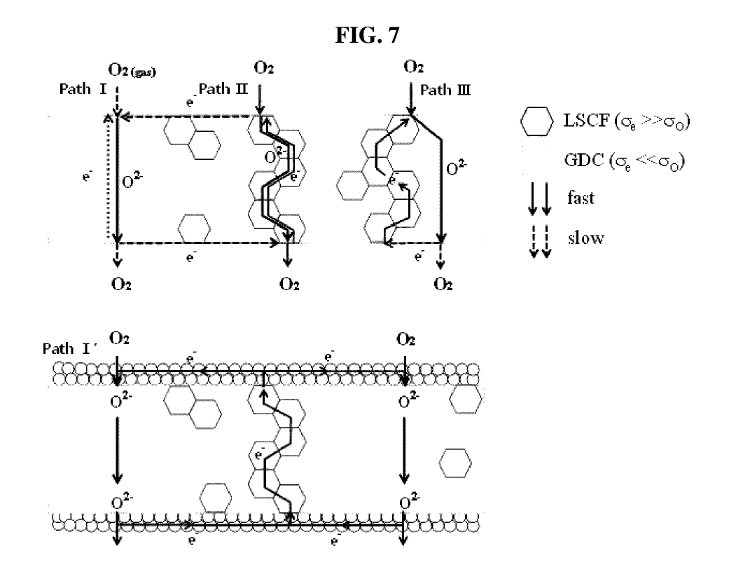

To determine the electrical properties of MIEC membranes according to various mixed volume ratio of LSM and GDC, electrical conductor LSM (electrical conductivity 240 S/cm, ionic conductivity 6×10⁻⁷ S/cm, 800° C.) and GDC (ionic conductivity 0.1 S/cm, 850° C.) were mixed in volume ratios of 1:9, 2:8, 3:7 and 5:5 and were used to prepare electronic-ionic mixed conducting membrane layers and the conductivity of the membranes were measured. For measurement, Ag paste was applied on each side of the membrane prepared in a disc form and the resistance was measured. Then the conductivity was determined using the area and thickness of the electrode. The results are shown in FIG. 7. The membrane prepared using 1:9 ratios of LSM and GDC showed no permeation thus having a low conductivity of 10⁻⁴ S/cm, in which case, the coating of the membrane on both sides with LSC electroactive layer was not enough to allow oxygen permeation through the membrane. In contrast, the membrane prepared using 2:8 ratios of LSM and GDC showed permeation having electrical conductivity of 1 S/cm (10,000 times), in which case, the coating of the membrane on both sides with LSC electroactive layer resulted in a high conductivity of at least 1 mL/cm² min. In the case of the membranes prepared using 3:7, 4:7 and 5:5 ratios of LSM and GDC, although they contained enough LSM to show good electric conductivity, they showed decreased oxygen permeability as the amount of GDC which is responsible for the oxygen permeation by ionic conductivity is decreased

Therefore from the result above it is determined that the membranes prepared using the volume ratios of 2:8 to 3:7 of LSM and GDC and coated on both sides with electroactive material, have an optimal membrane having excellent oxygen permeability, thermal stability and electric conductivity.

Thus La_{0.7}Sr_{0.3}MnO_{3±δ}(LSM) and Gadolinium doped ceria were mixed in a volume ratio of 2:8. The mixture was then added to a solvent for Tape casting, from which the tapes were prepared by using a Tape casting device in about 50 μm in thickness. The tapes were then stacked in various numbers and sintered 1300° C. to prepare EIMC membranes in thickness of 30-330 μm.

### Example 2

### Determination of Electrical Properties According to the Mixed Volume Ratio of LSCF and GDC

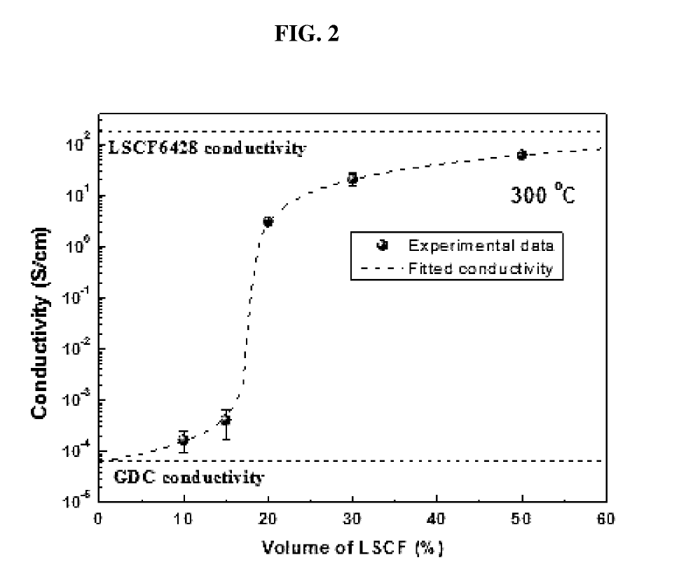

To determine the electrical properties of MIEC membranes according to various mixed volume ratio of LSCF and GDC, LSCF and GDC were mixed in volume rations of 1:9, 1.5:8.5, 2:8, 3:7 and 5:5 and used for preparing MIEC membrane layers, which were then used for measuring conductivity after being painted with Pt without electroactive layers. The results are shown in FIG. 2. The membrane prepared using 1:9 and 1.5:8.5 ratios showed no permeation thus not having a sufficient conductivity. In contrast, the membrane prepared using 2:8 ratio showed a dramatic increase of about 10,000 times in the electrical conductivity. This indicates that it is the ratio of about 2:8 from which the permeation starts to generate and leads to a sufficient electronic conduction.

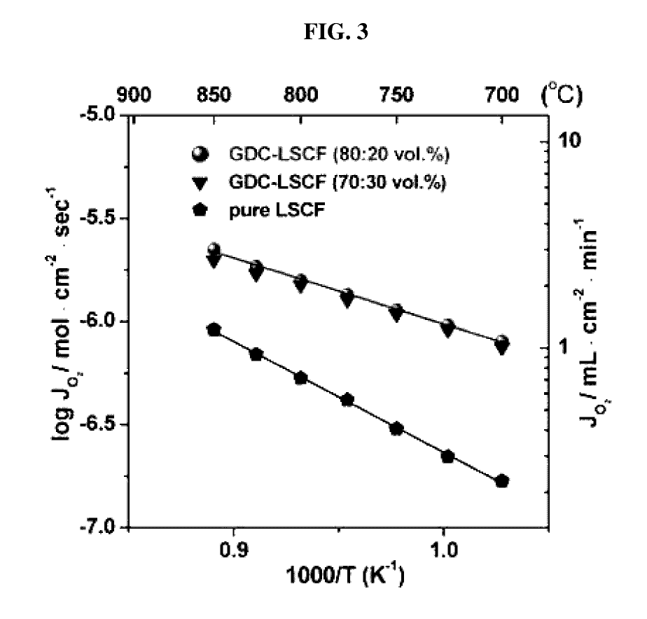

LSCF and GDC were mixed in volume ratios of 2:8 and 3:7. Each of the mixture was used to prepare EIMC membrane layers in 60 μm in thickness which were then coated with LSC mixed conductive electroactive layers on both sides. Then the oxygen permeability was measured using the membranes. Results are shown in FIG. 3. Also single phase separation membrane in 60 μm in thickness made of mixed conductive material LSCF were prepared and coated on both sides thereof with LSC conductive active layer. Then the oxygen conductivity was compared to that of the membrane coated with LSC mixed conductive electroactive layer on both sides thereof. As a result, the LSCF-GDC mixed membrane layers coated with mixed conductive electroactive layer on both sides showed oxygen conductivity 3 times higher than that of LSCF having at least 1 mL/cm² min of oxygen permeability at a temperature as low as 700° C.

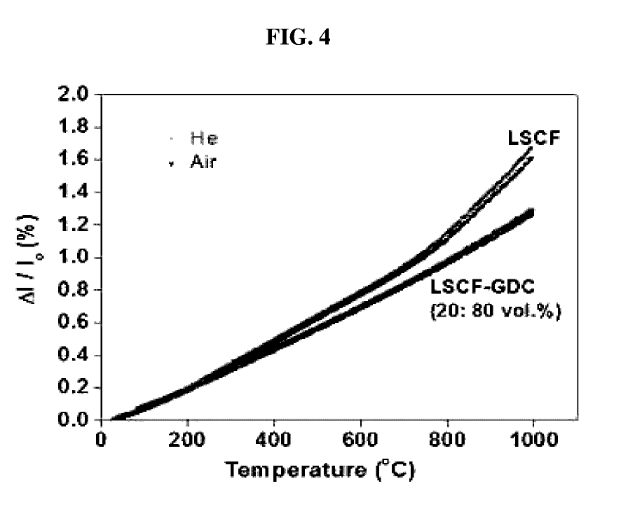

FIG. 4 is a graph showing the thermal expansion coefficient of EIMC layer prepared with LSCF and GDC in a ratio of 2:8 under various temperature, which was measured under He (red dots) and Air (black dots). The coefficients graph of the single phase LSCF is composed of two areas using linear slope model. The behavior of TEC of LSCF in two areas may be explained in two different structures the membrane adopts. In the low temperature area under about 700° C. (TEC: 13.8×10⁻⁶K⁻¹ in air and 14.4×10⁻⁶K⁻¹ in He), the expansion arises from the atom vibrations. At the high temperature area of 700° C. or more (TEC: 23.3×10⁻⁶K⁻¹ in air and 25.1×10⁻⁶K⁻¹ in He), the extra contribution from the thermal expansion arises from the oxygen deficiency, called chemical expansion. In the case of dual phase membranes (80 vol. % GDC20 vol. % LSCF), the chemical expansion is dramatically alleviated by the addition of GDC. TEC of the two phase membrane over the entire temperature (30˜1000° C.) was 13.1×10⁻⁶K⁻¹ under oxygen condition and 13.3×10⁻⁶K⁻¹ under He condition. These results indicate that the membrane including fluorite in large amount has a good mechanical stability.

### Example 3

### Determination of Oxygen Conductivity of the Membranes with Various Electroactive Layers

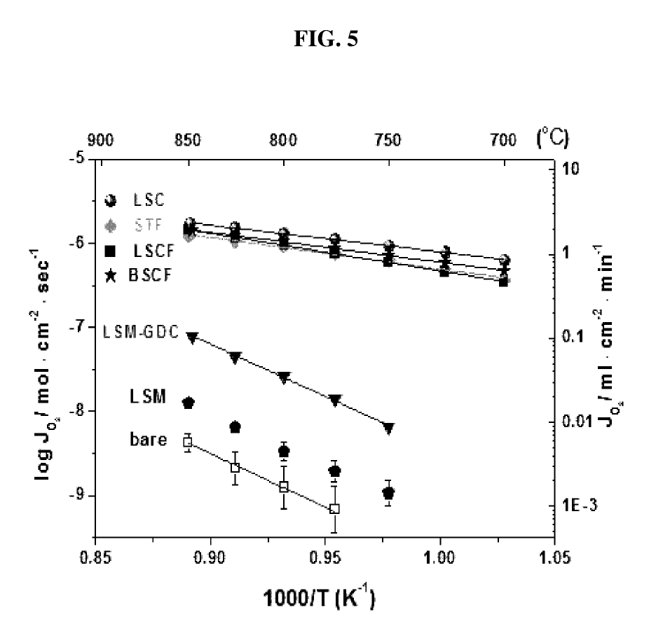

The LSCF-GDC (20:80) EIMC layer (80 μm in thickness) prepared in Example 2 was coated with electroactive layer of La_{0.6}Sr_{0.4}CoO₃(LSC), Sr_{0.5}Ti_{0.5}FeO₃(STF), La_{0.6}Sr_{0.4}Co_{0.2}Fe_{0.8}O₃(LSCF), Ba_{0.5}Sr_{0.5}CO_{0.8}Fe_{0.2}O₃(BSCF), La_{0.7}Sr_{0.3}MnO₃(LSM) or La_{0.7}Sr_{0.3}MnO₃—Ce_{0.9}Gd_{0.1}O_{2-δ}(LSM-GDC). Each of the electroactive layer materials was coated on the membrane in 30 μm in thickness by a hand printing method using a slurry brush and then the coated membranes were heat-treated at 1000° C. The oxygen conductivity of the membranes prepared was then measured at 800° C. Results are shown in FIG. 5. The oxygen conductivity of LSC, STF, LSCF and BSCF at 850° C. were 1 mL/cm² min or more. LSM-GDC and LSM showed higher oxygen conductivity compared to that of the bare EIMC membrane that are not coated with electroactive layer. However, they showed an oxygen conductivity lower (0.1 mL/cm² min or less) than that of the LSC, STF, LSCF and BSCF membranes coated with electroactive layer. Referring to Table 1, when mixed conductive LSC, STF, LSCF and BSCF having at least 10 S/cm of electric conductivity and 0.03 S/m of ionic conductivity were used as electroactive layers, the membranes have a high oxygen conductivity due to a high rate (K_{chem}) of an oxygen reduction reaction (O₂+4 e⁻2O⁻²) at the surface. LSM with low ionic conductivity showed a relatively low oxygen conductivity. Therefore, as the electroactive layers of the present oxygen separation membrane, materials having at least 10 S/cm of electric conductivity and 0.03 S/m of ionic conductivity namely k value of at least 10⁻⁶ are suitable.

TABLE 1
Electric conductivity, ionic conductivity and rate of reduction reaction.

| Material | ElectricConductivity(S/cm) | IonicConductivity(S/cm) | K_{chem} (cm/sec) |
|---|---|---|---|
| La_{0.7}Sr_{0.3}MnO₃ | 240 ^{[1]} | 6 × 10⁻⁷ ^{[2]} | 1.1 × 10⁻⁸ ^{[3]} |
| La_{0.6}Sr_{0.4}Co_{0.2}Fe_{0.8}O₃ | 269 ^{[4]} | 0.058 ^{[5]} | 5.9 × 10⁻⁶ ^{[6]} |
| Ba_{0.5}Sr_{0.5}Co_{0.8}Fe_{0.2}O₃ | 20~50 ^{[7]} | ~0.3 ^{[8]} | 2 × 10⁻⁴ ^{[9]} |
| SrTi_{0.5}Fe_{0.5}O₃ | 1.8 ^{[10]} | 0.036 ^{[10]} | 5 × 10⁻⁵ ^{[10]} |
| La_{0.6}Sr_{0.4}CoO₃ | 1600 ^{[11]} | 0.22 ^{[12]} | 1.1 × 10^{-5[13]} |

^{[1]} Y. Sakaki at. al, solid state ionics (1999), 118, 187-194.
^{[2]} J. Fleig, at. al., fuel cell, (2008), 8, 330-337.
^{[3]} J. C. Grenier at. al,. ECS Transaction (2009), 25(2), 2537-2546.
^{[4]} J. W. Stevenson at. al., J. Electrochem. soc., (1996), 143, 2722-2729.
^{[5]} H. UIImann at. al., J. Electrochem. soc., (2000), 138, 79-90.
^{[6]} J. A. Lane, at. al., solid state ionics (1999), 121, 210-208.
^{[7]} J-I. Jung, at. al., solid state ionics (2010), 181, 1287-1293.
^{[8]} W. K. Hong, at. al., journal of membrane science (2010), 346, 353-360.
^{[9]} E. Girdauskaite, at. al., solid state ionics (2008), 179, 385-392.
^{[10]} W. C. jung, at. al., solid state ionics (2009), 180, 843-847.
^{[11]} C. sun at. al., J Solid State Electrochem. (2010), 14, 1125-1144.
^{[12]} T. Teraoka, at. al., Mat. Res. Bull., (1988), 23, 51-58.
^{[13]}L. Wang, at. al., Applied Physics Letters (2009), 94,

### Example 4

### Determination of Oxygen Conductivity of the Membranes Under Symmetrical and Unsymmetrical Conditions of the Coating

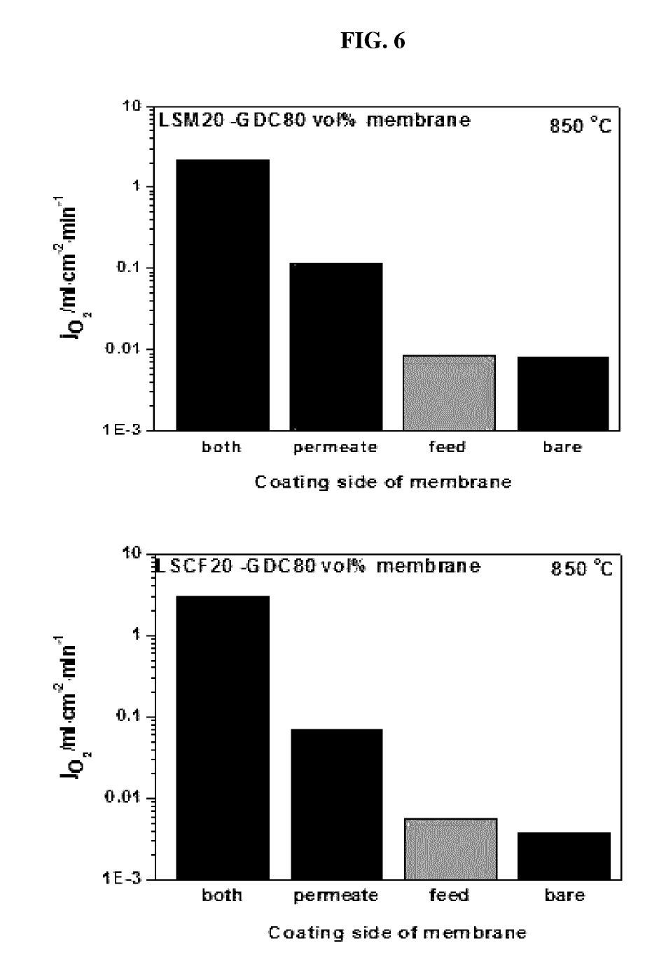

To measure the oxygen conductivity of the membranes under symmetrical and unsymmetrical conditions of the electroactive layer coating, oxygen separation membranes in 60 μm in thickness were prepared as described in Example 1 and 2, in which EIMC membranes were coated with LSC with a hand printing method using a slurry brush and sintered. Then oxygen conductivities were measured under Air/He condition on the EIMC membrane uncoated (bare), EIMC membrane with only one side coated (side with a higher or lower oxygen partial pressure) with electroactive layer, and EIMC membrane with both sides coated with electroactive layer. Results are shown in FIG. 6.

In the case of oxygen separation membrane with a side (feed side) having a higher oxygen partial pressure coated with electroactive layer, no difference was found in the oxygen conductivity with the bare membrane. In the case of oxygen separation membrane with a side (permeate side) having a lower oxygen partial pressure coated with electroactive layer, the oxygen conductivity of the membrane was increased about 10 times compared to the bare membrane. In the case of both sides of the membrane was coated with electroactive layer, the oxygen conductivity of the membrane was increased about 1000 times compared to the bare membrane showing 1 mL/cm² min or more of oxygen conductivity under Air/He oxygen partial pressure difference (for LSCF-GDC, 700° C.; for LSM-GDC, 750° C.). This indicates that the oxygen separation membrane coated with electroactive layers made of mixed conducting materials such as LSC have a high oxygen conductivity.

FIG. 7 is a schematic diagram showing the mechanism of oxygen permeation through the MIEC membrane coated with mixed conductive electroactive layers on both sides according to one embodiment of the present disclosure. To explain the mechanism of the coating improving the oxygen conductivity, membranes with or without an electroactive coating were compared. In GDC membrane indicated as Path I, changes are occurring at the surface thereof, in which O₂ is decomposed and reduced at the surface and diffused into the membrane layer, however due to the electron carriers which are not sufficient, the rate of Path I is very slow. In contrast, Path I′ in which both sides of the membrane were coated with LSC shows a different behavior. The electrons provided from LSCF due to the role of LSC layer having a high conductivity in the oxygen feed side rapidly distributes on the surface thus facilitating the ionization of oxygen molecule over the entire membrane surface. At the oxygen permeation side, free electrons produced from the molecularization of oxygen ions can be transported to the electron path permeated LSCF. When just one side is coated with electroactive layer, only Path I reaction is activated. Both sides are required to be coated with electroactive layers to obtain both mixed ionic and electronic conductivity.

### Example 5

### Determination of Oxygen Conductivity with Varying Thickness of the Membranes Coated on Both Sides Thereof

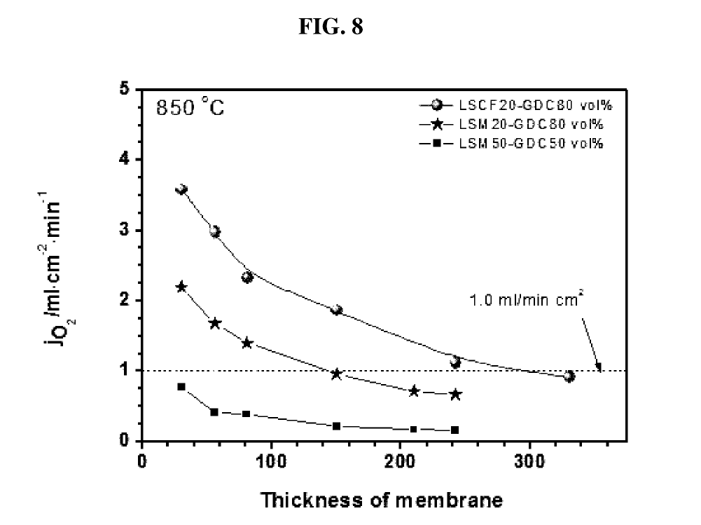

Oxygen conductivity was measured on the EIMC membranes, LSCF-GDC (20:80), LSM-GDC (20:80) and LSM-GDC (50:50) of Examples 1 and 2 with varying thickness in the range of 30-330 μm in thickness with or without the electroactive layer coating. Referring to FIG. 8, oxygen separation membranes, LSCF-GDC (20:80) and LSM-GDC (20:80) with electroactive coating at 850° C. had a high conductivity compared to LSM-GDC (50:50). Also the higher oxygen conductivity was obtained at a decreased thickness. This is due to the reduced time required for oxygen diffusion as the thickness of the membrane is decreased. Thus to obtain the oxygen conductivity of 1 mL/cm² min or more, it is preferable that the EIMC membrane have a thickness of 300 μm or thinner (for LSM-GDC, 100 μm or thinner).

### Example 6

### Determination of Oxygen Conductivity of the Electroactive Layer Having Asymmetric Material and Thickness

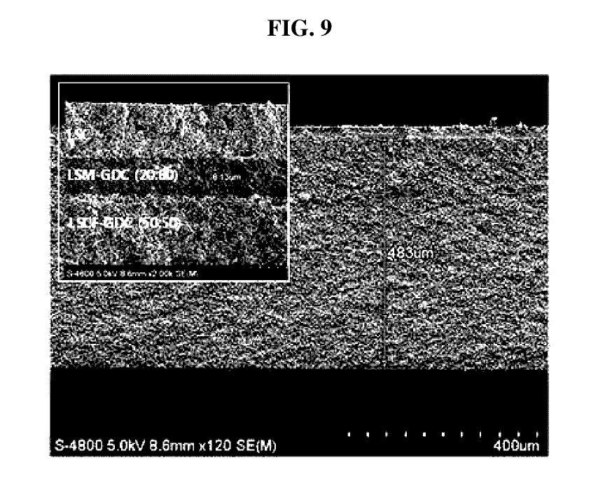

LSM-GDC (20:80) mixed membranes of Example 1 were treated to have electroactive layer on both side asymmetrically. For this as in Examples 1 and 3, LSM-GDC mixed membranes were formed to a tape and LSCF-GDC (50:50) was mixed with carbon black, a pore former and formed to a tape. Then the formed LSCF-GDC (50:50) tapes were continuously stacked on which the formed LSM-GDC tape prepared as above was layered and sintered at 1300° C. to prepare an asymmetrical membrane in which LSCF-GDC porous membrane support was stacked with dense LSM-GDC mixed membrane layer. Then the membrane prepared was painted with LSC slurry and sintered at 1000° C. to prepare the membrane as in FIG. 9 which is asymmetrical in terms of thickness and electroactive layer material.

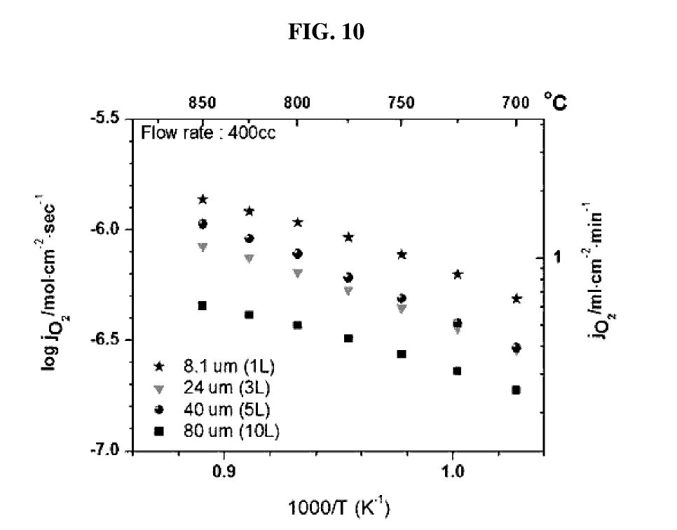

Then oxygen conductivity of the EIMC as prepared above was measured and shown in FIG. 10. In this case, the thickness of the membrane was controlled to have 8-80 μm as increasing the number of LSM-GDC stacked on the support layer (LSCF-GDC). As shown in FIG. 10, oxygen conductivity was found to be increased as the thickness of the dense mixed membrane layer is decreased. When the thickness of the mixed membrane is 40 μm or less, the oxygen conductivity of 1 mL/cm² min or more can be obtained at a temperature 750-800° C. or more.

Thus, the EIMC membranes coated on both side thereof with electroactive layer according to the present disclosure was found to have a high oxygen conductivity when the thickness and electroactive materials used are asymmetrically configured.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the methods, devices, and materials are described herein.

What is claimed is:

1. An oxygen separation membrane comprising:
an ion-electronic mixed membrane layer with about 20 μm to about 300 μm in thickness wherein the ion-electronic mixed membrane layer comprises a mixture of either an electronic conductive material or an ionic-electronic mixture and an ionic conductive material in a volume ratio from about 2:8 to about 3:7,
porous electroactive layers which are coated on both sides of the ion-electronic mixed membrane layer symmetrically or asymmetrically with about 20 μm to about 100 μm in thickness wherein the electroactive layers comprise least one ion-electronic mixed conductive materials.

2. The membrane of claim 1, wherein the ion-electronic mixed membrane layer comprises a mixture of the electronic conductive material and the ionic conductive material having an ion conductivity of about 0.1 S/cm or more wherein the electronic conductivity of the ion-electronic mixed membrane layer is about 0.5 S/cm or more, and wherein the electroactive layer has an electronic conductivity of about 10 S/cm or more, and an ion conductivity of about 0.03 S/cm or more.

3. The membrane of claim 1, wherein the electronic conductive material is at least one selected from a group consisting of Lanthanum strontium Manganite, Lanthanum strontium Chromite, MnFe₂O₄, and NiFe₂O₄.

4. The membrane of claim 1, wherein the ionic conductive material is at least one selected from a group consisting of yttria-stabilized zirconia, scandia-stabilized zirconia, gadolinia doped-ceria, Samaria doped-Ceria, Lanthanum gallates doped with magnesium and strontium, and Bismuth oxide.

5. The membrane of claim 1, wherein the ionic-electronic mixed conductive material is at least one selected from a group consisting of SrTi1-xFexO3-δ, Lanthanum strontium ferrite, Lanthanum strontium cobaltite, Strontium cobalt ferrite, Barium strontium cobalt ferrite, Lanthanum strontium cobalt ferrite and Lanthanum nickelate.

6. A method of fabricating the membrane according to claim 1, comprising:
preparing an ion-electronic mixed membrane layer using a tape casting process in which each of either an electronic conductive material or an ionic-electronic material is mixed with an ionic conductive material in a volume ratio from about 2:8 to about 3:7;
sintering and densificating the membrane layer at about 1200° C. to about 1400° C.;
coating both sides of the ion-electronic mixed membrane layer with a porous electroactive layer in a thickness of about 20 μm to about 100 μm; and
heat-treating the coated membrane at a temperature of about 900° C. to about 1100° C.

7. The method of claim 6, wherein the ion-electronic mixed membrane layer is prepared by combining the electronic conductive material and the ionic conductive material having an ion conductivity of about 0.1 S/cm or more wherein the electronic conductivity of the ion-electronic mixed membrane layer is about 0.5 S/cm or more, and wherein the electroactive layer has an electronic conductivity of about 10 S/cm or more, and an ion conductivity of about 0.03 S/cm or more.

8. The method of claim 6, wherein the electronic conductive material is at least one selected from a group consisting of Lanthanum strontium Manganite, Lanthanum strontium Chromite, MnFe₂O₄, and NiFe₂O₄.

9. The method of claim 6, wherein the ionic conductive material is at least one selected from a group consisting of yttria-stabilized zirconia, scandia-stabilized zirconia, gadolinia doped-ceria, Samaria doped-Ceria, Lanthanum gallates doped with magnesium and strontium, and Bismuth oxide.

10. The method of claim 6, wherein the ionic-electronic mixed conductive material is at least one selected from a group consisting of SrTi1-xFexO3-δ, Lanthanum strontium ferrite, Lanthanum strontium cobaltite, Strontium cobalt ferrite, barium strontium cobalt ferrite, Lanthanum strontium cobalt ferrite and Lanthanum nickelate.

11. A method of fabricating the membrane according to claim 1, comprising:
preparing an ion-electronic mixed membrane layer using a tape casting process in which either an electronic conductive material or an ionic-electronic material is mixed with an ionic conductive material in a volume ratio from about 2:8 to about 3:7;
coating both sides of the ion-electronic mixed membrane layer with a porous electroactive layer in a thickness of about 20 μm to about 100 μm; and
sintering and densificating the coated membrane layer at about 1200° C. to about 1400° C.;

12. The method of claim 11, wherein the ion-electronic mixed membrane layer is prepared by combining the electronic conductive material and the ionic conductive material having an ion conductivity of about 0.1 S/cm or more wherein the electronic conductivity of the ion-electronic mixed membrane layer is about 0.5 S/cm or more, and wherein the electroactive layer has an electronic conductivity of about 10 S/cm or more, and an ion conductivity of about 0.03 S/cm or more.

13. The method of claim 11, wherein the electronic conductive material is at least one selected from a group consisting of Lanthanum strontium Manganite, Lanthanum strontium Chromite, MnFe₂O₄, and NiFe₂O₄.

14. The method of claim 11, wherein the ionic conductive material is at least one selected from a group consisting of yttria-stabilized zirconia, scandia-stabilized zirconia, gadolinia doped-ceria, Samaria doped-Ceria, Lanthanum gallates doped with magnesium and strontium, and Bismuth oxide.

15. The method of claim 11, wherein the ionic-electronic mixed conductive material is at least one selected from a group consisting of SrTi1-xFexO3-δ, Lanthanum strontium ferrite, Lanthanum strontium cobaltite, Strontium cobalt ferrite, barium strontium cobalt ferrite, Lanthanum strontium cobalt ferrite and Lanthanum nickelate.
